(19) United States
(12) Patent Application Publication
(10) Pub. No.: US 2003/0063042 A1
(43) Pub. Date: Apr. 3, 2003

(54) ELECTRONIC UTILITY DEVICES INCORPORATING A COMPACT VIRTUAL IMAGE DISPLAY

(76) Inventors: ASHER A. FRIESEM, REHOVOT (IL); BENJAMIN SHARON, REHOVOT (IL); YAIR DAVID, RAMAT HASHARON (IL)

Correspondence Address: Sol Scheinbein, G E Ehrlich (1995) Ltd, Anthony Castorina, 2001 Jefferson Davis Highway Suite 207, Arlington, VA, 22202, US

(21) Appl. No.: 09/362,888

(22) Filed: Jul. 29, 1999

(51) Int. Cl. G09G 5/00

(52) U.S. Cl. 345/6; 345/9

(57) ABSTRACT

An electronic utility device is provided. The device includes a user input interface and a user output interface, the user output interface including a compact virtual display for providing visual information to the user, the compact virtual display including (a) a light-transmissive substrate; (b) an input diffractive optical element integrally formed with the light-transmissive substrate; (c) an output diffractive optical element integrally formed with the light-transmissive substrate laterally of the input diffractive optical element; and (d) an image source for producing a real image, the image source optically communicating with the input diffractive optical element so as to collimate the real image into plane waves transmittable along an optical path through the light-transmissive substrate, such that when the plane waves impinges on the output diffractive optical element the plane waves are focused to form a virtual image which correspond to the real image and which is viewable by the user.

### FIELD AND BACKGROUND OF THE INVENTION

The present invention relates to electronic utility devices and, more particularly, to electronic utility devices incorporating compact virtual image display which utilizes diffractive optical elements (DOEs) and planar optics so as to minimize both the complexity and thickness of the display.

With the advent of the Internet and cellular telephony, personal and compact, portable electronic utility devices have become a mainstay of modem daily living.

Most of these electronic devices include some form of an image display which provides visual information to the user. Since most of these electronic devices are compact, image displays which can be incorporated into such devices must also be provided in a compact form. In particular, it is of importance that the thickness of the image display employed be minimal, the thickness of the display referring to a dimension thereof which is perpendicular to the plane of the image formed by the display.

A displayed image may be either a real image or a virtual image.

A real image refers to an image which is observed directly by the unaided human eye. A real image exists at a given location and can be observed by the unaided eye if a viewing surface is positioned at that location. A photograph is an example of a real image. Examples of electronic displays which provide real images include liquid crystal displays (LCDs), cathode ray tubes (CRTs) monitors and projection screens. Compact electronic devices, due to their small size, have a limited surface area on which a real image can be provided. Since the amount of detail that the human eye can resolve per unit of area is limited, devices which provide a real image are only capable of providing a limited amount of legible information per display screen.

As such, one approach to reduce the size of an image display and yet retain image quality is through the formation of a virtual image instead of a real image. By definition, a virtual image can exist at a location where no display surface exists. An example of a virtual image is the image of fine print viewed through a magnifying glass. Another example is a hologram. A mirror reflected image provides yet another example.

Virtual image displays can provide an image which appears to be larger than the source object from which the virtual image emerges. As a result, the size of the virtual image, as perceived by the user, is limited by the magnification of the image display as opposed to the size of the display itself. This enables virtual image displays to provide the user with a greater amount of legible information per display screen than real image displays utilizing the same area. It also enables a virtual image display to be designed so as to provide the same amount of information per screen as real image displays utilizing a substantially smaller area.

In general, virtual image displays include a source object which is magnified by one or more optics to provide a virtual image along an image plane. The thickness of the virtual image display device, i.e., the dimension of the display device that is perpendicular to the image plane of the virtual image, is dependent on the physical separation between the components of the image display device.

U.S. Pat. No. 5,892,624 to Kintz et al., describes a virtual image display which is made thinner through the use of an immersed beam splitter, and in one embodiment, total internal reflection. The image display includes an imaging surface on which a source object is formed, a first optical element having a reflective function and a magnification function, a second optical element having a magnification function, and an immersed beam splitting element positioned between the first and second optical elements. The immersed beam splitting element includes a beam splitter surrounded by an optically transparent material having a refractive index greater than that of air. An illumination source projects the source object formed at the imaging surface through the optically transparent material to the beam splitter. The beam splitter reflects the projected source object to the first optical element. The first optical element magnifies the projected source object and reflects a magnified virtual image of the projected source object to the beam splitter. The magnified virtual image traverses the beam splitter to the second optical element which magnifies the magnified virtual image to produce a compound magnified virtual image of the source object.

Although this system provides a viewable virtual image, the utilization thereby of conventional optical elements which include one or more lenses greatly complicates the fabrication of this system, and in addition adds undesirable thickness and bulkiness. Furthermore, the dependency on lenses necessitates careful and precise alignment of the optical elements to achieve the desired image.

WO 94/19712, which is incorporated by reference as if fully set forth herein, teaches the use of planar optics in holographic visor displays. To achieve a holographic doublet display a collimating lens collimates the light from a light source to form an array of plane waves which are diffracted within a substrate and outward by the linear grating. However, WO 94/19712 fails to teach the incorporation of such a display in electronic utility devices. Furthermore, being for image overlapping, such a display is not at all applicable per se for use in electronic utility devices.

There is thus a widely recognized need for, and it would be highly advantageous to have, electronic utility devices incorporating compact virtual image display which utilizes diffractive optical elements (DOEs) and planar optics so as to minimize both the complexity and thickness of the display.

### SUMMARY OF THE INVENTION

According to the present invention there is provided an electronic utility device comprising a user input interface and a user output interface, the user output interface including a compact virtual display for providing visual information to the user, the compact virtual display including (a) a light-transmissive substrate; (b) an input diffractive optical element integrally formed with the light-transmissive substrate; (c) an output diffractive optical element integrally formed with the light-transmissive substrate laterally of the input diffractive optical element; and (d) an image source for producing a real image, the image source optically communicating with the input diffractive optical element so as to collimate the real image into plane waves transmittable along an optical path through the light-transmissive substrate, such that when the plane waves impinges on the output diffractive optical element the plane waves are focused to form a virtual image which correspond to the real image and which is viewable by the user.

According to further features in preferred embodiments of the invention described below, the output diffractive optical elements is positionable in close proximity to an eye of the user so as to relay the virtual image to the user without substantially blocking the field of view of the eye of the user.

According to further features in preferred embodiments of the invention described below, the output diffractive optical element is positioned opposite a see through window formed in the light-transmissive substrate.

According to still further features in the described preferred embodiments the image source is optically communicating with the input diffractive optical element through at least one waveguide, such that the light-transmissive substrate is positionable remote from the image source.

According to still further features in the described preferred embodiments the output diffractive optical elements is positionable in close proximity to an eye of the user so as to relay the virtual image to the user without substantially blocking the field of view of the eye of the user.

According to still further features in the described preferred embodiments at least one of the input and the output diffractive optical elements is a diffraction grating.

According to still further features in the described preferred embodiments the diffraction grating is constructed and designed to handle a multiplicity of plane waves and/or spherical waves arriving from a range of angles, and/or having a range of wavelengths.

According to still further features in the described preferred embodiments the light-transmissive substrate includes a light transparent plate and an emulsion coating thereon on which the input and the output diffractive optical elements are formed.

According to still further features in the described preferred embodiments the input and the output diffractive optical elements are located substantially in a co-planar orientation on the light-transmissive substrate.

According to still further features in the described preferred embodiments a surface of the light-transmissive substrate which is aligned with the input diffractive optical element but opposite to that receiving the real image is opaque.

According to still further features in the described preferred embodiments a surface of the light-transmissive substrate which is aligned with the output diffractive optical element but opposite to that from which the virtual image is viewed is opaque.

According to still further features in the described preferred embodiments the electronic utility device further comprising either a refractive or diffractive lens being in optical communication with the input diffractive optical element such that light originating from the real image is at least partially collimated by the lens prior to being collimated by the input diffractive optical element.

According to still further features in the described preferred embodiments the electronic utility device further comprising at least one additional diffractive optical element being positioned between the input and the output diffractive optical elements, the additional diffractive optical element being so positioned so as to further collimate the plane waves transmitted through the light-transmissive substrate.

According to still further features in the described preferred embodiments the electronic utility device further comprising a prism being positioned between the image source and the input diffractive optical element such that light originating from the real image is redirected by the prism onto the input diffractive optical element.

According to still further features in the described preferred embodiments the optical path is defined within the light-transmissive substrate by substantially total internal reflection.

According to still further features in the described preferred embodiments the light-transmissive substrate includes at least one light waveguide embedded therein, being for optically coupling the input and the output diffractive optical elements so as to define the optical transmission path.

According to still further features in the described preferred embodiments the input and the output diffractive optical elements are constructed and designed such that the virtual image which is viewable through the output diffractive optical element is a magnification of the real image. Such a magnification can be effected by a magnifying lens or a magnifying diffractive optical element, placed between the image source and the input diffractive optical element.

According to still further features in the described preferred embodiments the image source is selected from the group consisting of a liquid crystal display, a cathode ray tube, , a flat panel display (FPD), a light emitting diode (LED), a passive matrix LCD (PMLCD), an active matrix LCD (AMLCD), a reflective LCD, a vacuum fluorescent tube, an electroluminescent plasma-EL tube, a field emission display, a low temperature polycrystalline Si-TFT LCD, an organic electroluminescent display, a micro electromechanical (MEM) display, an active matrix electroluminesence display, a ferroelectric liquid crystal, a virtual retinal display (VRD), a spatial light modulator display, a plasma display, a light valve display, a 2-D light emitting diode array display and a 2-D laser array display

According to still further features in the described preferred embodiments the electronic utility device is selected from the group consisting of a cellular communication device, a satellite phone, a personal digital assistant, a global positioning system, a wearable computer, a palmtop computer a video and a camera viewfinder.

According to still further features in the described preferred embodiments the device is a cellular communication device and further wherein the compact virtual display is designed so as to be positionable in front of an eye of a user when the cellular communication device is in use.

According to still further features in the described preferred embodiments the device is an earset of a communication device and further wherein the compact virtual display is designed so as to be positionable in front of an eye of a user when the earset is in use.

The present invention successfully addresses the shortcomings of the presently known configurations by providing an electronic utility device incorporating a compact virtual image display which permits substantial miniaturization of the display and therefore use thereof in front of an eye of a user without substantially blocking the field of view of the user.

### BRIEF DESCRIPTION OF THE DRAWINGS

The invention is herein described, by way of example only, with reference to the accompanying drawings, wherein:

FIG. 1 is a cross sectional view of a prior art planar interconnect utilizable by the present invention.

FIG. 2a is a cross sectional view illustrating a cellular telephone incorporating a compact virtual display according to the present invention;

FIG. 2b is another cross sectional view illustrating a cellular telephone incorporating a compact virtual display according to the present invention;

FIG. 2c is a simplified top view illustration of a cellular telephone incorporating a compact virtual display according to the present invention;

FIG. 2d is a schematic illustration of a cellular telephone incorporating a compact virtual display according to the present invention;

FIGS. 3a-b are top and perspective views, respectively, illustrating one configuration of a remote display of an electronic utility device according to the present invention;

FIGS. 4a-b are top and perspective views, respectively, illustrating another configuration of a remote display of an electronic utility device according to the present invention;

FIG. 5 is a perspective view illustrating an earset incorporating a display of an electronic utility device according to the present invention;

FIG. 6 illustrates the geometry of a planar optics holographic doublet for visor display (prior art);

FIG. 7 illustrates the unfolded configuration of the holographic doublet of FIG. 6;

FIG. 8 illustrates the relationship of spot size to input angle in the display of FIG. 6;

FIG. 9 illustrates experimental spot size in the focal plane in the corrected visor display of FIG. 6; and

FIG. 10 illustrates the chromatic variations in the lateral focal position in the display of FIG. 6.

### DESCRIPTION OF THE PREFERRED EMBODIMENTS

The present invention is of an electronic utility device which incorporates a compact virtual display utilizing planar optics so as to provide visual information by way of a virtual image to a user. By utilizing planar optics, a compact virtual display can be readily incorporated with an electronic utility device such as, for example, a cellular telephone in a variety of configurations which allow the viewing of a clear, sharp virtual image without substantially blocking the field of view of the user.

As used herein in the specification and in the claims section that follow the phrases “diffractive optical element” and “holographic optical element” are used interchangeably.

Over the last thirty years there has been significant progress in replacing conventional optical elements with diffractive optical elements (DOEs). Such DOEs can be used in combination with planar optic configurations, in what is termed as planar interconnects (see, Friesem A. A. and Amitai Y. Planar diffractive elements for compact optics. Trends in optics. 125-144, October 1996).

As is further detailed hereinunder the compact virtual display of the electronic utility device of the present invention utilizes a planar interconnect to provide a viewable virtual image.

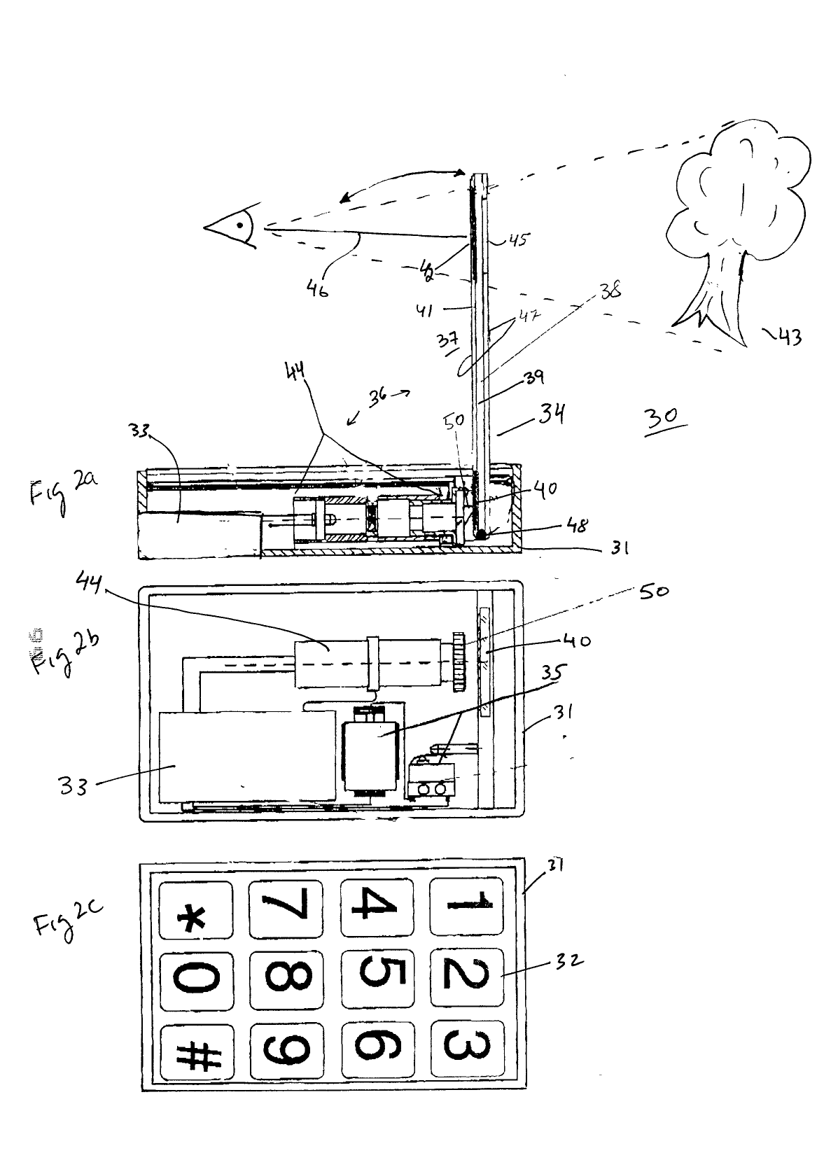

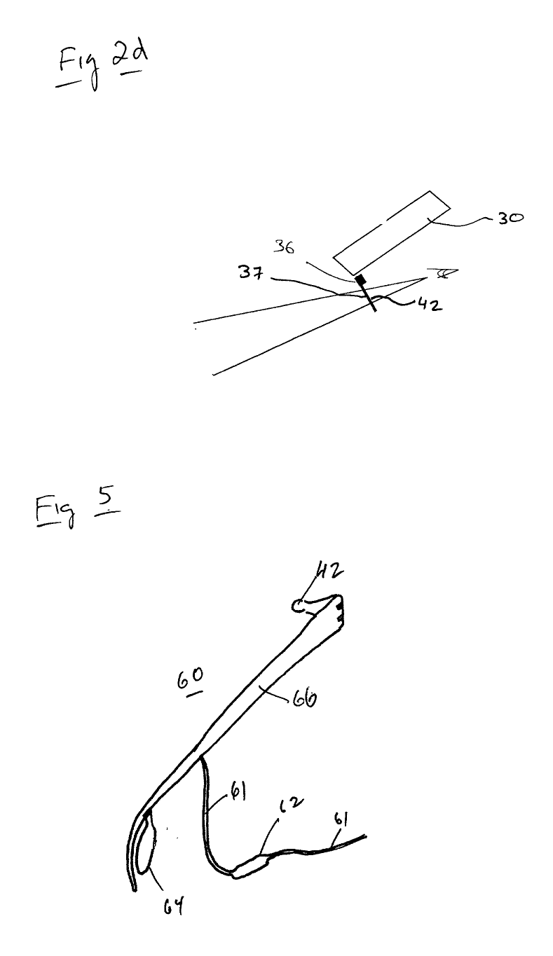

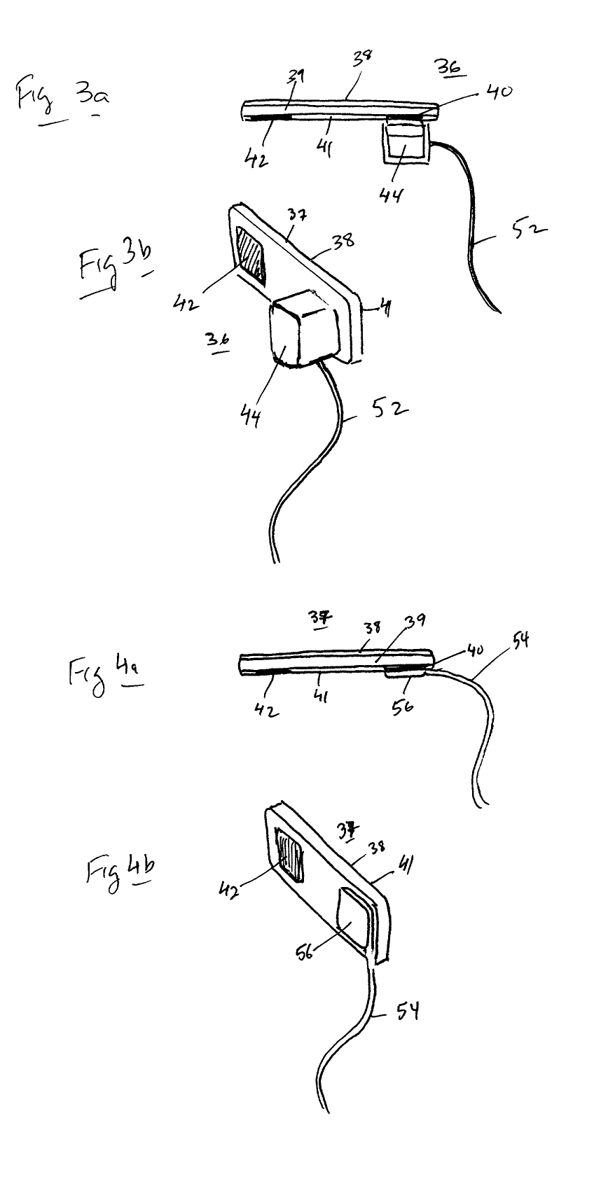

For purposes of better understanding the present invention, as illustrated in FIGS. 2-5 of the drawings, reference is first made to the construction and operation of a basic planar interconnect as described in Friesem and Amitai, 1996 (ibid), which is incorporated herein by reference.

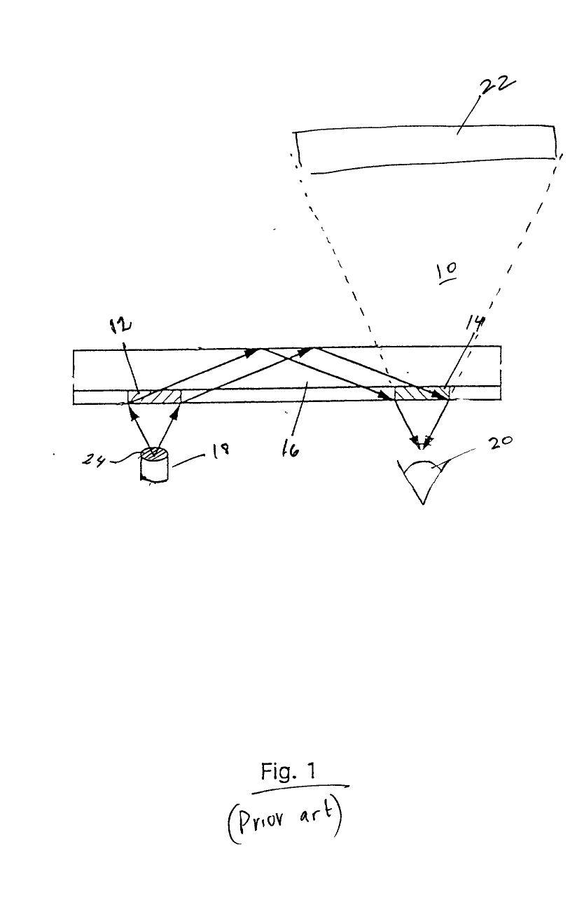

FIG. 1 illustrates the basic building block of a planar interconnect configuration, which is referred to hereinbelow as planar interconnect 10. Planar interconnect 10 includes an input diffractive optical element 12 and an output diffractive element 14 which are recorded or etched as volume or surface gratings on substrate 16. Diffractive optical elements are referred to hereinunder as elements. Elements 12 and 14 are typically recorded at predetermined distances apart on the same plane (as shown) or opposite planes of substrate 16 although other recording configurations which include more than two elements positionable on various planes of a substrate 16 can also be realized. For example, substrate 16 can include at least one additional (e.g., a third) element recorded within substrate 16. Substrate 16 can be composed of any material which posses a good refractive index, and is transparent to light propagating therein. Examples of such material include, but are not limited to, glass, plastics, polymers such as, for example, polymethyl methacrylate and polyvinyl chloride. In addition substrate 16 is fabricated substantially free of contaminating air bubbles and particles. Substrate 16 can be coated with a reflective coating such that the bouncing angles inside substrate 16 can be reduced. Alternatively substrate 16 can be constructed of a material possessing a non-uniform refractive index or poor transmittance, but which is provided with an optical path by way of a plurality of light waveguides, typically a bundle of optic fiber, preferably coherent fibers, optionally one fiber per picture element, e.g., pixel.

By recording elements 12 and 14 as volume gratings either complex or simple, it is possible to alleviate the problems of low efficiency and poor angular wavelength discrimination associated with surface gratings. The volume gratings are interferometrically recorded in thick phase materials for obtaining high diffraction efficiencies, typically greater than 90%. In addition, volume gratings have relatively high angular and wavelength discriminations in accordance with the Bragg relation.

An image source 18 generated light waves are collimated by element 12 into plane waves that are trapped inside the substrate by total internal reflection. Image source 18 can be, but is not limited to, a front or back-light liquid crystal display, or a cathode ray tube. The waves trapped inside the substrate can be further collimated by the third element described above. The planar waves impinge on element 14 and as a result are focused thereby onto output detector 20.

As such, planar interconnect 10 establishes an optical transmission path which can be used for various applications. For example, planar interconnect 10 can be used to generate a virtual image 22 viewable by an eye of a person by processing through planar interconnect 10 a real image 24 generated by image source 18.

Since planar interconnect 10 can be directly adjacent to the planes of source 18 and detector 20 it can be compact and modularized which is of particular importance in applications which necessitate miniaturization, such as the compact virtual display of the electronic utility device of the present invention.

It will be appreciated that a large number of element pairs can be recorded on a single substrate to provide optical interconnects for a large number of source-detector pairs. Each diffractive doublet can transmit more than one channel simultaneously.

Such planar interconnects can be used for division multiplexing/demultiplexing systems, compact holographic beam expanders and compressors and holographic visor and head up displays, as is further detailed in WO 94/19712 and in Friesem and Amitai, 1996.

Of particular relevance to the compact virtual display of the present invention is the holographic visor display described in WO 94/19712 which is further detailed hereinunder in the Example section.

Due to their specific function, holographic visor displays are not restricted to the size and image quality limitations imposed on the compact virtual display of the present invention. As such, the configuration described in WO 94/19712 cannot be readily utilized to generate a viewable virtual image in, for example, a cellular telephone. Not withstanding from the above, the teachings of WO 94/19712 does provide data as to the ability of planar interconnects to provide viewable virtual images. As such, the present invention exploits some of the advantages of the planar interconnect configurations described therein.

The principles and operation of an electronic utility device incorporating a compact virtual display according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

According to the present invention there is provided an electronic utility device which incorporates a compact virtual display for displaying visual information to a user.

Referring again to the drawings, FIGS. 2a-c illustrate an electronic utility device according to the present invention which is referred to herein as device 30. For illustrative purposes device 30 depicted in the following Figures is a cellular telephone. However it is to be understood that device 30 of the present invention can be any electronic utility device, such as, but not limited to, personal communicators, such as, for example, the NOKIA Communicator, personal electronic organizers, personal digital assistants (PDA), pagers, video and camera viewfinders, mobile telephones, such as but not limited to cellular and satellite telephones, television monitors, portable global positioning systems (GPS) and other hand held electronic devices.

Device 30 in accordance with the teachings of the present invention includes a housing 31, for housing a battery 33, electronics 35 and a user input interface 32 which can include a keypad and a microphone powered by battery 33 and communicating with electronics 35. User input interface 32 serves for effecting the various user input functions associated with cellular telephones. A user output interface 34 powered by battery 33 and communicating with electronics 35 is also provided within housing 31. User output interface 34 includes a compact virtual display device 36 for providing visual information to the user. The visual information can include alphanumeric data, still images and video images displayed either monochromatically or in color. User output interface 34 also includes a speaker for providing audio output to the user. The speaker can be used to receive audio information unrelated to the images alphanumeric data or video provided by display device 36, such as audio information associated with a conversation. In addition, the speaker can provide audio information that is related to images text or video provided by display device 36.

Since electronic utility devices are generally hand carried and thus compact it is imperative that display device 36 is compact and thin so as to be incorporatable into device 30. As such, to provide a virtual image to a user of device 30, display device 36 includes a planar interconnect 37, which is similar in construction and function to planar interconnect 10 of FIG. 1.

Planar interconnect 37 includes a light-transmissive substrate 38. Substrate 38 is typically composed of a light transparent plate 39 provided with a layer of photosensitive or lightsensitive polymer coating 41, such as, an emulsion coating, such that a substantially total internal reflection of light waves is obtained within substrate 38. Planar interconnect 37 also includes an input element 40 and an output element 42 both formed or recorded within coating 41 of substrate 38. Input and output elements function in processing light waves as is further described hereinabove.

Substrate 38 can also be composed of any material such as plastics, composites or metals, provided that light waveguides are disposed within substrate 38 as described above in order to establish an optical path between elements 40 and 42.

Display device 36 further includes an image source 44 which is powered by battery 33 and communicates with electronics 35. Image source 44 serves for producing a real image according to data received or generated by electronics 35. To produce a real image, image source 44 includes an imaging element which can include, for example, a liquid crystal display (LCD), a cathode ray tube (CRT) a flat panel display (FPD), a light emitting diode (LED), a passive matrix LCD (PMLCD), an active matrix LCD (AMLCD), a reflective LCD, a vacuum Fluorescent tube, an electroluminescent plasma-EL tube, a field emission display, a low temperature polycrystalline Si-TFT LCD, an organic electroluminescent display, a micro electromechanical (MEM) display, an active matrix electroluminesence display, a ferroelectric liquid crystal, a virtual retinal display (VRD), a spatial light modulator display, a plasma display, a light valve display, a 2-D light emitting diode array display or a 2-D laser array display. Image source 44 optically communicates with input element 40 such that waves from the real image provided thereby are collimated by element 40 into plane waves which are transmittable through substrate 38 to element 42. Element 42 focuses these plane waves into a virtual, preferably magnified image 43 representing the real image. This virtual image is viewable when an eye of a user is positioned at a predetermined distance or a predetermined distance range 46 from element 42. Typically distance 46 ranges from 3-15 cm and depends largely on the user. Since the image perceived by the user is a virtual image it can be magnified many folds over the real image, which magnification is limited only by the optics employed. This magnification can be determined by the configuration and design of planar interconnect 37 which is further detailed hereinbelow in the Example section. For example a 10-50 or more fold magnification can be provided by interconnect 37 while still retaining high image quality. When providing a magnified virtual image, the surface area of element 42 can be extremely small and yet be able to provide a large, highly resolved viewable image. For example, to achieve an image of a viewable area of 900 cm², an element 42 is selected with a surface area of 1 cm² (i.e., 30 fold linear magnification). It will be appreciated that depending on the electronic utility device and specific function of display device 36, an element 42 can be configured of any surface area size so as to produce any desired viewing area size.

It will be further appreciated that since an element 42 of a small surface area can be utilized with display device 36, display device 36 can be designed so as not to substantially block the field of view of a user when in use. As such, a user viewing a virtual image provided by element 42 is still afforded with a substantially full field of view of the surrounding environment. This is particularly advantageous when device 30 is used while the user thereof is occupied with other tasks which require a substantially unoccluded field of view such as, for example, walking.

As an alternative or in addition, output diffractive optical element 42 is positioned behind a see through (transparent) window 45 formed in interconnect 37 opposite element 42.

In order to render image display device 36 usable, it is configured such that element 42 can be positioned in close proximity to an eye of a user while device 30 is in use. Opaque covers or coats 47 can be employed on either or both sides of interconnect 37, so as to block external light interference, if so required.

As specifically shown in FIGS. 2a and 2d, and according to a preferred embodiment of the present invention, display device 36 is designed such that element 42 is positioned remote from housing 31 when display device 36 is in use. To provide such remote positioning, planar interconnect 37 is hingedly attached to housing 31 through an articulating hinge 48 such that planar interconnect 37 can be rotated to one of several open positions according to the user's dimensions and preferences. It will be appreciated that the above described configuration is especially applicable to cellular telephones. Thus, a planar interconnect 37, can be positioned in front of a user's eye, when the cellular telephone is in use and collapsed into a protective and compact configuration when not in use.

Due to personal positioning preferences, display device 36 must be usable when positioned in any of several spatial positions. Since such positioning of planar interconnect 37 would not allow for an optimal alignment between element 40 and image source 44 display device 36 also includes an optical element 50 which can be, for example, a lens, a prism or a bundle light wave guides, such as optic fibers, and which serve to direct the light provided from image source 44 such that it is provided to element 40 in an optimal alignment path.

It will be appreciated that planar interconnect 37 can be configured to any shape and length such that element 42 can be provided in proximity to an eye of a user when housing 31 is either handheld or carried on the clothing of the user.

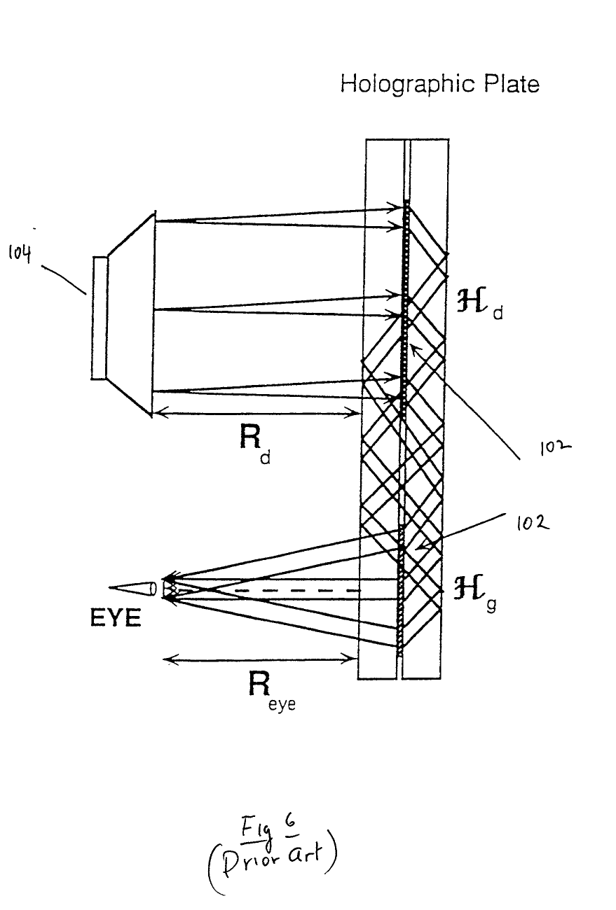

According to another preferred embodiment of the present invention, and as specifically shown in FIGS. 3a and 3b, display device 36 is provided remote from housing 31. According to the shown configuration, both image source 44, substrate 38 and elements 40 and 42 are provided remote from housing 31. As such, display device 36 is connected to battery 33 and electronics 35 through wire 52 such that both power and data are provided to image source 44 through wire 52.

According to another preferred embodiment of the present invention, and as specifically shown in FIGS. 4a and 4b, planar interconnect 37 is provided remote from an image source 44 which is itself contained within housing 31. In this case, image source 44 is optically coupled with input element 40 through a light wave guide bundle, e.g., a coherent optical fiber bundle 54 which is characterized in that each fiber in the bundle transfers light originating at one pixel of image source 44 from image source 44 to element 40. Thus, an image generated from image source 44 is transmitted through optical fiber bundle 54 directly, or alternatively through a lens 56, to element 40.

It will be appreciated that by providing either planar interconnect 37 or display device 36 as a whole remote from device 30, as is further described hereinabove, a user can position element 42 in close proximity to an eye of a user, while at the same time conveniently either hand carry device 30 or carry device 30 on or in a clothing item.

Such remote positioning of planar interconnect 37 or display 15 device 36 can be effected manually by the user. As such, when in use, planar interconnect 37 or display device 36 can be hand positioned in front and in close proximity to the user's eye. When not in use, planar interconnect 37 or display device 36 can be stowed away.

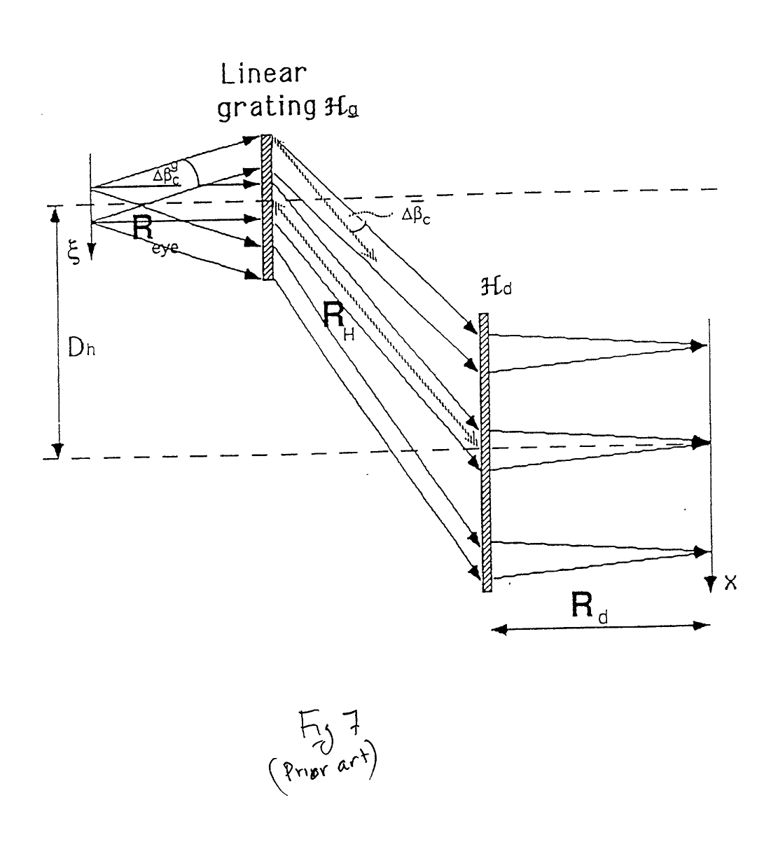

Alternatively, according to another preferred embodiment of the present invention, and as specifically shown in FIG. 5, planar interconnect 37 or display device 36 are attached to an earset 60 of device 30. Earset 60 includes a speaker designed as an earpiece 64. It preferably further includes a microphone 62. Both earpiece 64 and microphone 62 are powered by battery 33 and communicate with electronics 35 of device 30 through a line 61. Line 61 also serve to provide display device 36 (in the remote display configuration) with power and data link. In the remote planar interconnect 37 configuration, link 61 co-houses an optic fiber bundle so as to provide interconnect 37 with optical data from image source 44 of display device 36. When in use, earset 60 is positioned on the head of the user via a temple element 66 such that earpiece 64 is positionable in proximity to, or within, the user's ear, microphone 62 is positionable in proximity to the user's mouth and element 42 is positionable in proximity to, and in front of, a user's eye to operate as described hereinabove. Microphone 62, earpiece 64 and element 42 are adjustable for comfort and fit. It will be appreciated that since earset 60 is positionable on the head of a user, when in use, a minimal bulk configuration is preferred. As such, employing in earset 60 the planar interconnect 37 remote configuration as further described hereinabove, is preferred. It will further be appreciated that earset 60 can be configured to be collapsible such that it can be conveniently stowed away when not in use.

Thus, an electronic utility device according to the present invention provides numerous advantages over prior art devices. By employing a compact virtual display which utilizes a planar interconnect, which employs planar optics and diffractive optical elements, a magnified high resolution virtual image can be provided to a user with an addition of minimal bulk and minimal electronic componentry. In sharp contrast, prior art devices which include various displays which typically employ LCD screens which provide a real image, are limited by the additional bulk and complexity added by these displays. Furthermore, compact electronic utility devices such as cellular telephones cannot readily utilize such prior art displays to provide a large highly resolved image since due to their bulk and complexity they are only limited to a very small viewable image.

Finally, since the display incorporated into an electronic utility device according to the present invention provides a large viewable image from a small surface area, it can readily be designed so as not to substantially block the field of view of an eye of a user, and as such provides the user with a substantially full field of view while in use.

Additional objects, advantages, and novel features of the present invention will become apparent to one ordinarily skilled in the art upon examination of the following example, which is not intended to be limiting. Additionally, each of the various embodiments and aspects of the present invention as delineated hereinabove and as claimed in the claims section below finds experimental support in the following example.

### EXAMPLE

Reference is now made to the following example, which together with the above descriptions, illustrate the invention in a non limiting fashion.

Planar (substrate-mode) optics schemes are exploited for recording holographic doublet visor display (HDVD), by utilizing a corrected collimating lens and a simple linear grating. The lens collimates the light from the input display to form an array of plane waves, which are diffracted and trapped inside the substrate. The grating then diffracts the trapped light outward. In order to achieve low aberrations, the collimating lens is recorded with pre-distorted waves which are derived recursively from holograms, recorded with spherical waves, whose readout geometries differ from those used during recording.

An inherent advantage of these HDVD is that they can be incorporated into relatively compact systems.

This is further illustrated by designing and recording a compact HDVD. The recording was at a wavelength of 458 nm and the readout at 633 nm. The results reveal that this HDVD can handle field of view (field of view) of ±6°, with essentially diffraction-limited performance, and low chromatic sensitivity.

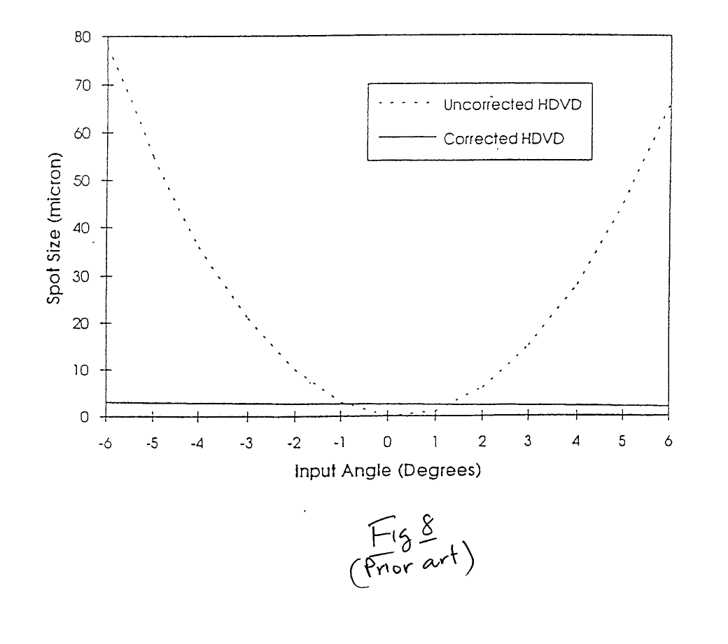

The readout geometry for the HDVD is schematically presented in FIG. 6.

The doublet includes two holographic elements 102 (also referred to as diffractive optical elements), a collimating lens H_{d}, and a simple linear grating H_{g} both of which are recorded on the same substrate. A two-dimensional display 104 is located at a distance R_{d} from the center of H_{d}, where R_{d} is the focal length of H_{d}. The light from the display is thus transformed into an angular spectrum of plane wavefronts by H_{d}. Specifically, each spatial frequency of the input is diffracted into plane waves at an angle \overline{β}ᵢ^{d}(x) inside the substrate, where x is the lateral coordinate of H_{d}. To assure that the image waves will be trapped inside the plate by total reflection, \overline{β}ᵢ^{d}(x) must satisfy the following relation:

v≧sin βᵢ^{d}(x)=vsin \overline{62}ᵢ^{d}(x)≧1 (1)

where v is the refractive index of the glass plate. The linear grating H_{g} diffracts the trapped wavefronts outward. An observer, located at a io distance Rₑᵥₑ, thus sees an image of the display, located at infinity. In reality, the light rays emerging from the display, are collected and imaged by the HDVD onto the observer's eye. Nevertheless, it is more convenient to analyze the aberrations, caused by the HDVD, by inverting the direction of the light rays. Thus, the readout waves of H_{g} form an angular spectrum of plane waves (each having the diameter of the eye's pupil dₑᵥₑ), that emerge from the eye and are focused by the HDVD onto the display plane. The central wave is focused to the center of the display, whereas the foci of the other waves are laterally displaced.

The design of the linear grating H_{g} is straightforward. It has a grating function

$${H}_{g} = \frac{2 π}{{λ}_{c}} v sin {\overline{β}}_{i}^{g} \cdot ξ ,$$

where λ_{c} is the readout wavelength, ξ is the lateral coordinate of H_{g} and \overline{β}ᵢ^{g}(0)=\overline{β}ᵢ^{d}(0) is the off-axis angle of the central ray inside the substrate. The design of the collimating lens H_{d} is much more complicated. The basic relations for a simple holographic imagery lens, recorded with spherical waves, is given as:

$$μ ( \frac{1}{{R}_{o}} - \frac{1}{{R}_{r}} ) = \frac{1}{{R}_{d}} \\ μ ( sin {β}_{r} - sin {β}_{o} ) = sin {β}_{c} \qquad ( 2 )$$

where c, o and r are the indices for the reconstruction, object and reference waves, respectively, R_{q} (q=o, r) is the distance between the respective point source and the center of the hologram, β_{q} (q=o, r) is the respective off-axis angle, β_{c}, is defined as β_{c}=v\overline{β}_{c}≡v\overline{β}ᵢ^{g}(0) and μ is the ratio between the readout and the recording wavelengths (i.e.,

$$μ = \frac{{λ}_{c}}{{λ}_{o}}$$

).

Unfortunately, a simpler holographic lens, recorded with only spherical waves, has, in general, very large aberrations over the entire field of view. In order to compensate for the large aberrations, it is necessary to record the holographic lens with two aspherical waves.

There are several methods for designing and recording holographic imaging lens with low aberrations. The recursive design technique was chosen because the recording procedure is relatively simple and there is no need to resort to computer-generated holograms that require sophisticated recording equipment. In this recursive design and recording method, aspheric wavefronts for recording the final collimating lens are derived from interim holograms.

Specifically, the aspheric object and reference waves are derived from intermediate holograms, H^{o} and H^{r}, respectively. Note, from now on, the superscript o will denote all the parameters that are related to H^{o}, and the superscript r the parameters related to H^{r}).

In order to avoid large astigmatism and coma in the center of the field of view, the H_{d} must be recorded with a combination of plane waves and on-axis spherical waves. If the reference waves of H^{o} and H^{r} are defined as plane waves, i.e., Rᵣ^{o}=Rᵣ^{r}=∞ and the object and reconstruction waves of H^{o} and H^{r} as spherical waves normal to the hologram plane, i.e., sin βₒ^{o}=sin β_{c}^{o}=sin βₒ^{r}=sin β_{c}^{r}=0, the imaging equations can be rewritten as:

$$μ ( \frac{1}{{R}_{o}^{o}} + \frac{1}{{R}_{c}^{o}} - \frac{1}{{R}_{o}^{r}} - \frac{1}{{R}_{c}^{r}} ) = \frac{1}{{R}_{d}} \\ μ ( sin {β}_{r}^{o} - sin {β}_{r}^{r} ) = sin {β}_{c} \qquad ( 3 )$$

It is apparent from FIG. 6 that when a single plane wave, representing a particular spatial frequency, is focused by H_{d} to a point in the output plane, it illuminates only part of the overall hologram. Thus, each viewing angle may be defined with a local hologram whose aberrations must be determined and minimized.

Let one consider the local hologram at a distance x from the center of the overall hologram. The relevant parameters for the overall hologram are denoted as R_{q}^{p},β_{q}^{p} and those for the local hologram as R_{q}^{p}(x),β_{q}^{p}(x), where q=o, c and p=o, r. Under the assumption of small angles, the parameters of the interim holograms, are:

$$\begin{matrix}sin {β}_{q}^{p} ( x ) ≅ \frac{x}{{R}_{q}^{p}} - \frac{1}{2} \frac{{x}^{3}}{{( {R}_{q}^{p} )}^{3}} & ( 4 ) \\ {R}_{q}^{p} ( x ) = \frac{{R}_{q}^{p}}{cos {β}_{q}^{p} ( x )} ≅ \frac{{R}_{q}^{p}}{1 - \frac{1}{2} {sin}^{2} {β}_{q}^{p} ( x )} ≅ \frac{{R}_{q}^{p}}{1 - \frac{1}{2} {( \frac{x}{{R}_{q}^{p}} )}^{2} + \frac{1}{2} {( \frac{x}{{R}_{q}^{p}} )}^{4}} & ( 5 )\end{matrix}$$

sin βᵣ^{p}(x)=sin βᵣ^{p} (6)

When Δ\overline{β}_{c} is sufficiently small, the following can be written:

sin \overline{β}_{c}(x)=sin(\overline{β}_{c}+Δ\overline{β}_{c})=sin \overline{β}_{c}+Δ\overline{β}_{c} cos β_{c} (7)

By using the holographic imaging equation, it is possible to derive,

$$sin ( {\overline{β}}_{c} + Δ {\overline{β}}_{c} ) = sin {\overline{β}}_{c} + \frac{Δ {β}_{c}^{g}}{v} = sin {\overline{β}}_{c} + \frac{ξ ( x )}{{vR}_{eye}} \qquad ( 8 )$$

Combining Equations (7) and (8) yields:

$$Δ {\overline{β}}_{c} = \frac{ξ ( x )}{{vR}_{eye} cos {\overline{β}}_{c}} \qquad ( 9 )$$

In accordance with the geometry of FIG. 7, the relation between the lateral coordinate ξ of H_{g}, and the lateral coordinate x of H_{d}, can be represented by:

$$\begin{matrix}ξ ( x ) = x - \frac{{R}_{H} {Δβ}_{c}}{cos {\overline{β}}_{c}} = x - \frac{{R}_{H} ξ ( x )}{{vR}_{eye} {cos}^{2} {\overline{β}}_{c}} & ( 10 ) \\ \frac{ξ ( x )}{{vR}_{eye}} = \frac{x}{{vR}_{eye} + \frac{{R}_{H}}{{cos}^{2} {\overline{β}}_{c}}} & ( 11 )\end{matrix}$$

or

where R_{H} is the unfolded distance between the center of the two holograms. Substituting Equation (11) into Equation (8), yields:

$$sin {\overline{β}}_{c} ( x ) = sin {\overline{β}}_{c} + \frac{x}{{vR}_{eye} + \frac{{R}_{H}}{{cos}^{2} {\overline{β}}_{c}}} \qquad ( 12 )$$

Using Equations (4)-(6) and Equation (12) it is possible to determine the relevant parameters of the image waves, via the following:

sin β₍ᵢ₎(x)=v sin \overline{β}_{c}(x)+μ(sin β_{c}^{o}(x)+sin βₒ^{o}(x)−sin βᵣ^{o}(x)−sin β_{c}^{r}(x)−sin βₒ^{r}(x)+sin βᵣ^{r}(x))=

$$sin {β}_{c} + \frac{x}{{R}_{eye} + \frac{{R}_{H}}{v {cos}^{2} {β}_{c}}} + μ ( x ( \frac{1}{{R}_{c}^{o}} + \frac{1}{{R}_{o}^{o}} - \frac{1}{{R}_{c}^{r}} - \frac{1}{{R}_{o}^{r}} ) - sin {β}_{r}^{o} + sin {β}_{r}^{r} ) = \frac{x}{{R}_{eye} + \frac{{R}_{H}}{v {cos}^{2} {β}_{c}}} - \frac{x}{{R}_{d}} \qquad ( 13 )$$

where i is the index for the image waves of H_{d}. By representing

$${R}_{d} = {R}_{eye} + \frac{{R}_{H}}{v {cos}^{2} {β}_{c}} ,$$

a simple equality can be defined as follows:

sin βᵢ(x)≡0 (14)

If the display surface is parallel to the hologram surface, then,

Rᵢ₍ₓ₎=−R_{d}.

Thus, using only the first and the second non-vanishing orders of

$$\frac{χ}{{R}_{q}^{p}}$$

in Equations (4) and (5), yields the various aberrations of the local hologram.

These can be represented by the following:

$$\begin{matrix}S ( x ) = \frac{- 1}{{R}_{i}^{3} ( x )} + μ {\sum }_{{p = o , r}_{q = c , o}} {{ϵ}_{p} ( \frac{1}{{R}_{q}^{p} ( x )} )}^{3} \\ = \frac{1}{{R}_{d}^{3}} + μ ( {\sum }_{{p = o , r}_{q = c , o}} {{ϵ}_{p} ( \frac{1}{{R}_{q}^{p}} )}^{3} - \frac{3}{2} {x}^{2} {\sum }_{{p = o , r}_{q = c , o}} {{ϵ}_{p} ( \frac{1}{{R}_{q}^{p}} )}^{5} )\end{matrix}$$

$$\begin{matrix}C ( x ) = μ {\sum }_{{p = o , r}_{q = c , o}} {ϵ}_{p} \frac{sin {β}_{q}^{p} ( x )}{{( {R}_{q}^{p} ( x ) )}^{2}} \\ = μ ( x {\sum }_{{p = o , r}_{q = c , o}} {{ϵ}_{p} ( \frac{1}{{R}_{q}^{p}} )}^{3} - \frac{3}{2} {x}^{3} {\sum }_{{p = o , r}_{q = c , o}} {{ϵ}_{p} ( \frac{1}{{R}_{q}^{p}} )}^{5} )\end{matrix}$$

$$\begin{matrix}A ( x ) = μ {\sum }_{{p = o , r}_{q = c , o}} {ϵ}_{p} \frac{{sin}^{2} {β}_{q}^{p} ( x )}{{R}_{q}^{p} ( x )} \\ = μ ( {x}^{2} {\sum }_{{p = o , r}_{q = c , o}} {{ϵ}_{p} ( \frac{1}{{R}_{q}^{p}} )}^{3} - \frac{3}{2} {x}^{4} {\sum }_{{p = o , r}_{q = c , o}} {{ϵ}_{p} ( \frac{1}{{R}_{q}^{p}} )}^{5} )\end{matrix}$$

$$\begin{matrix}F ( x ) = \frac{- 1}{{R}_{i} ( x )} + μ {\sum }_{{p = o , r}_{q = c , o}} {ϵ}_{p} \frac{1}{{R}_{q}^{p} ( x )} \\ = μ ( - \frac{{x}^{2}}{2} {\sum }_{{p = o , r}_{q = c , o}} {{ϵ}_{p} ( \frac{1}{{R}_{q}^{p}} )}^{3} + \frac{{x}^{4}}{2} {\sum }_{{p = o , r}_{q = c , o}} {{ϵ}_{p} ( \frac{1}{{R}_{q}^{p}} )}^{5} )\end{matrix}$$

where S, C and A denote the spherical, coma and astigmatism aberrations, respectively, and F denote the field curvature. Also, the parameter εₚ≡1 for p=o, and εₚ≡−1 for p=r. It is apparent from Equation (15) that the first and the second orders of the aberrations C(x), A(x) and F(x) can be canceled simultaneously, if the following conditions are fulfilled:

$${\sum }_{{p = o , r}_{q = c , o}} {{ϵ}_{p} ( \frac{1}{{R}_{q}^{p}} )}^{3} = {\sum }_{{p = o , r}_{q = c , o}} {{ϵ}_{p} ( \frac{1}{{R}_{q}^{p}} )}^{5} = 0 \qquad ( 16 )$$

The dominant aberration of H_{d} now becomes

$$S ( x ) = \frac{1}{{R}_{d}^{3}}$$

but, since the diameter of the eye dₑᵥₑ is typically much smaller than the focal length R_{d}, this spherical aberration is very small and its contribution to the overall spot size is small. The relations that describe the relevant parameters of the interim holograms are given in Equations (3) and (16). This is a set of four equations with six variables. There are infinite solutions to this set, and the exact solution can be chosen from various considerations such as increasing the diffraction efficiency of H_{d} or simplifying the recording procedure.

The design procedure used is illustrated here for a HDVD having the following parameters:

R_{d}=86.75 mm,R_{H}=32.9 mm,d_{eye}=4 mm, \overline{β}ᵢ^{g}=\overline{β}_{c}48°,

R_{eye}=40 mm,Dₕ=24 mm,Tₕ=3 mm,v=1.5,

λ₀=457.9 nm,λ_{c}=632.8 nm, [symbol] μ=1.38 (17)

where Dₕ is the lateral distance between the center of the two holograms, and Tₕ is the thickness of the substrate. In order to illuminate H_{d}(O) with the full width of the image wave of H_{g}(o), one must fulfill the relation 2 nTₕ tan \overline{β}ᵢ=Dₕ, where n is an integer. In this case, the desired relation is fulfilled with n=7. The performance of the doublet was checked over a field of view of ±6°, so the minimal angle inside the substrate can be represented by:

v sin \overline{β}_{c}^{min}(x)=v sin \overline{β}_{c}−sin(6^{o}) [symbol] sin \overline{β}_{c}^{min}(x)=42.4° (18)

Substituting Equation (18) into Equation (1), yields:

1.5>sin \overline{β}_{c}^{min}(x)=1.01>1 (19)

Equation (19) demonstrates that the necessary condition for total internal reflection is fulfilled over the entire field of view of ±6°. Inserting the values of Equation (17) into Equations (2) and (15) yields the parameters for H^{o} and H^{r}, as follows:

Rₒ^{o}=−167.5 mm,βᵣ^{o}=−79.92°,R_{c}^{o}=−202.42 mm,

Rₒ^{r}=−130 mm,βᵣ^{r}=−9.75°,R_{c}^{r}=202.02 mm. (20)

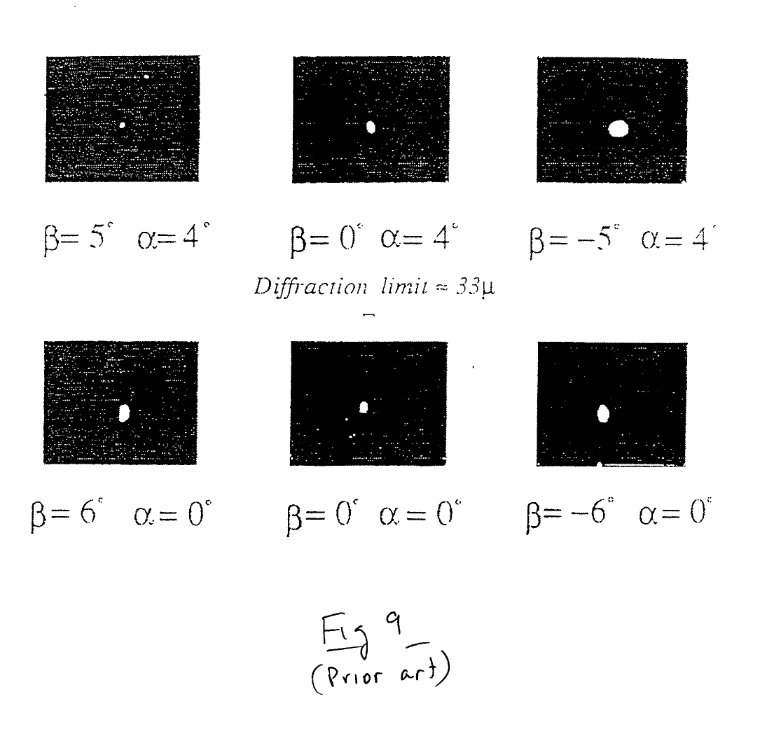

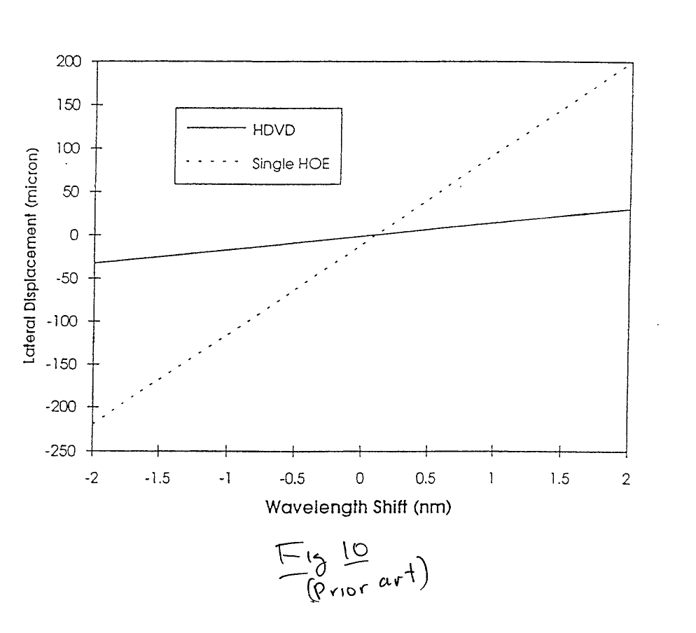

Employing the parameters of Equation (20), a simulation was performed in order to calculate the spot sizes for a corrected HDVD denoted by H₁, and for a noncorrected HDVD (which was recorded with spherical waves), denoted by H₂. FIG. 8 shows the calculated spot sizes for a field of view of ±6°. It is evident from the results that there is a significant improvement for H₁. The spot sizes for H₁ over the entire field of view are smaller than 33 μm, which is the diffraction-limited spot size, whereas those for H₂ are significantly greater. To verify this design, the interim holograms H^{o} and H^{r} were recorded. The exact image wavefronts from the interim holograms were transferred into the recording plane of the final element H₁, with the help of an intermediate hologram arrangement. The element H₁ was then tested by introducing plane waves from a rotating mirror at the location of the eye. FIG. 9 shows the experimental results for a field of view of ±6°. These results illustrate that H₁ indeed has an essentially diffraction-limited performance.

To illustrate the improved chromatic sensitivity of the HDVD the maximum lateral dispersion as a function of the output wavelength shift Δλ_{c} were calculated for two different visor displays. One included a single holographic element, and the other an HDVD with planar optics. The results are presented in FIG. 10. As shown, inside a bandwidth of ±2 nm, the lateral dispersion for the display with the HDVD is smaller than the diffraction-limited spot size. Moreover, this lateral dispersion is better by a factor of 7 than the lateral dispersion for the visor display with the single holographic optical element.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. An electronic utility device comprising a user input interface and a user output interface, said user output interface including a compact virtual display for providing visual information to the user, said compact virtual display including:
(a) a light-transmissive substrate;
(b) an input diffractive optical element integrally formed with said light-transmissive substrate;
(c) an output diffractive optical element integrally formed with said light-transmissive substrate laterally of said input diffractive optical element; and
(d) an image source for producing a real image, said image source optically communicating with said input diffractive optical element so as to collimate said real image into plane waves transmittable along an optical path through said light-transmissive substrate, such that when said plane waves impinges on said output diffractive optical element said plane waves are focused to form a virtual image which correspond to said real image and which is viewable by the user.

2. The electronic utility device of claim 1, wherein said output diffractive optical elements is positionable in close proximity to an eye of the user so as to relay said virtual image to the user without substantially blocking the field of view of said eye of the user.

3. The electronic utility device of claim 1, wherein said image source is optically communicating with said input diffractive optical element through at least one light waveguide, such that said light-transmissive substrate is positionable remote from said image source.

4. The electronic utility device of claim 3, wherein said output diffractive optical elements is positionable in close proximity to an eye of the user so as to relay said virtual image to the user without substantially blocking the field of view of said eye of the user.

5. The electronic utility device of claim 1, wherein at least one of said input and said output diffractive optical elements is a linear diffraction grating.

6. The electronic utility device of claim 5, wherein said linear diffraction grating is constructed and designed to handle a multiplicity of plane waves and/or spherical waves arriving from a range of angles, and/or having a range of wavelengths.

7. The electronic utility device of claim 1, wherein said light-transmissive substrate includes a light transparent plate and an emulsion coating thereon on which said input and said output diffractive optical elements are formed.

8. The electronic utility device of claim 1, wherein said input and said output diffractive optical elements are located substantially in a co-planar orientation on said light-transmissive substrate.

9. The electronic utility device of claim 1, wherein a surface of said light-transmissive substrate which is aligned with said input diffractive optical element but opposite to that receiving said real image is opaque.

10. The electronic utility device of claim 1, wherein a surface of said light-transmissive substrate which is aligned with said output diffractive optical element but opposite to that from which said virtual image is viewed is opaque.

11. The electronic utility device of claim 1, further comprising a lens being in optical communication with said input diffractive optical element such that light originating from said real image is at least partially collimated by said lens prior to being further collimated by said input diffractive optical element.

12. The electronic utility device of claim 1, further comprising at least one additional diffractive optical element being positioned between said input and said output diffractive optical elements, said additional diffractive optical element being so positioned so as to further collimate said plane waves transmitted through said light-transmissive substrate.

13. The electronic utility device of claim 1, further comprising a prism being positioned between said image source and said input diffractive optical element such that light originating from said real image is redirected by said prism onto said input diffractive optical element.

14. The electronic utility device of claim 1, wherein said optical path is defined within said light-transmissive substrate by substantially total internal reflection.

15. The electronic utility device of claim 1, wherein said light-transmissive substrate includes at least one light waveguide embedded therein, said at least one light waveguide optically coupling said input and said output diffractive optical elements so as to define said optical transmission path.

16. The electronic utility device of claim 1, wherein said input and said output diffractive optical elements are constructed and designed such that said virtual image which is viewable through said output diffractive optical element is a magnification of said real image.

17. The electronic utility device of claim 1, wherein said image source is selected from the group consisting of liquid crystal display (LCD), a cathode ray tube (CRT), a flat panel display (FPD), a light emitting diode (LED), a passive matrix LCD (PMLCD), an active matrix LCD (AMLCD), a reflective LCD, a vacuum Fluorescent tube, an electroluminescent plasma-EL tube, a field emission display, a low temperature polycrystalline Si-TFT LCD, an organic electroluminescent display, a micro electromechanical (MEM) display, an active matrix electroluminesence display, a ferroelectric liquid crystal, a virtual retinal display (VRD), a spatial light modulator display, a plasma display, a light valve display, a 2-D light emitting diode array display and a 2-D laser array display.

18. The electronic utility device of claim 1, wherein the electronic utility device is selected from the group consisting of a cellular communication device, a satellite phone, a personal digital assistant, a global positioning system, a palmtop computer a video and a camera viewfinder.

19. The electronic utility device of claim 1, wherein the device is a cellular communication device and further wherein said compact virtual display is designed so as to be positionable in front of an eye of a user when said cellular communication device is in use.

20. The electronic utility device of claim 1, wherein the device is an earset of a communication device and further wherein said compact virtual display is designed so as to be positionable in front of an eye of a user when said earset is in use.

21. The electronic utility device of claim 1, wherein said output diffractive optical element is positioned opposite a see through window formed in said light-transmissive substrate.
